(19) United States
(12) Patent Application Publication
(10) Pub. No.: US 2008/0236358 A1
(43) Pub. Date: Oct. 2, 2008

(54) Catheter trimmer

(76) Inventors: Jeffrey M. Vitullo, Sinking Spring, PA (US); William J. Vojtasek, Wyomissing, PA (US)

Correspondence Address: AMSTER, ROTHSTEIN & EBENSTEIN LLP, 90 PARK AVENUE, NEW YORK, NY, 10016, US

(21) Appl. No.: 11/729,368

(22) Filed: Mar. 27, 2007

(51) Int. Cl. B26D 1/30

(52) U.S. Cl. 83/663

(57) ABSTRACT

A catheter trimmer including a blade housing including a catheter insertion guide that guides a tip of a catheter along a side of the blade housing at an oblique angle relative to the side of the blade housing, and a blade disposed within the blade housing and pivotable about an axis perpendicular to the side of the blade housing, the blade having a pre-trimming position in which the blade is pivoted upwards to allow a catheter to be inserted into the catheter insertion guide, and a trimming position in which the blade is pivoted downwards through the catheter insertion guide to trim the catheter to the oblique angle.

### FIELD OF THE INVENTION

The present invention relates to a trimming device, and more particularly to a trimming device for trimming the tip of a catheter.

### BACKGROUND OF THE INVENTION

A catheter end user is required to trim a catheter once the proper length of the catheter is determined using an anatomical measuring technique. To aid in trimming, the catheter is printed with length markings along its shaft, starting from either catheter hub to catheter tip or from catheter tip to catheter hub. The end user then typically uses scissors or a trimmer provided by the catheter manufacturer to trim the catheter at the designated length marking. The resulting cut is perpendicular to the catheter shaft, resulting in a blunt, potentially trauma-inducing tip.

It is known to trim a catheter to an oblique angle in order to reduce the level of trauma that may be caused by the catheter tip. For example, U.S. Pat. No. 4,617,019 to Fecht et al. discloses the use of a blade or knife to cut a catheter to an oblique angle. However, the method according to Fecht does not provide a means for holding the catheter in position relative to the blade to obtain the oblique cut. Further, U.S. Pat. No. 4,872,455 to Pinchuk et al. discloses a scissor-like device for trimming a tubular structure. However, the Pinchuk device requires a user to hold the tubular structure perpendicular to the cutting die with one hand, while using the other hand to manipulate the scissor arms toward one another to produce the cut, which is an awkward movement resulting in potentially inaccurate cuts.

Accordingly, there is a need for a relatively simple device that allows a catheter end user to trim the catheter tip to an oblique angle and which also holds the catheter in proper position during the cutting operation.

### SUMMARY OF THE INVENTION

A catheter trimmer according to an exemplary embodiment of the present invention includes a blade housing and a blade disposed within the blade housing. The blade housing includes a catheter insertion guide that guides a tip of a catheter along a side of the blade housing at an oblique angle relative to the side of the blade housing. The blade is disposed within the blade housing and is pivotable about an axis perpendicular to the side of the blade housing. The blade has a pre-trimming position in which the blade is pivoted upwards to allow a catheter to be inserted into the catheter insertion guide, and a trimming position in which the blade is pivoted downwards through the catheter insertion guide to trim the catheter to the oblique angle.

A method of trimming a catheter according to an exemplary embodiment of the present invention includes pivoting a blade of a blade trimmer upwards to clear an obliquely-extending catheter insertion guide formed in a side of the blade trimmer, guiding a catheter tip into the catheter insertion guide of the blade trimmer, and pivoting the blade downwards into the catheter insertion guide to trim the catheter tip at the oblique angle.

These and other features of this invention are described in, or are apparent from, the following detailed description of various exemplary embodiments of this invention.

### BRIEF DESCRIPTION OF THE DRAWINGS

Various exemplary embodiments of this invention will be described in detail, with reference to the following figures, wherein:

FIG. 1 shows a catheter trimmer according to an exemplary embodiment of the present invention;

FIG. 2 is an exploded perspective view of the catheter trimmer shown in FIG. 1;

FIG. 3A shows the catheter trimmer of FIG. 1 with the blade in the pre-trimming position;

FIG. 3B shows the catheter trimmer of FIG. 1 with the blade in the trimming position; and

FIG. 4 is a boxplot showing results of an experiment evaluating stiffness of catheter tip samples cut at various tip angles.

### DETAILED DESCRIPTION OF PREFERRED EMBODIMENTS

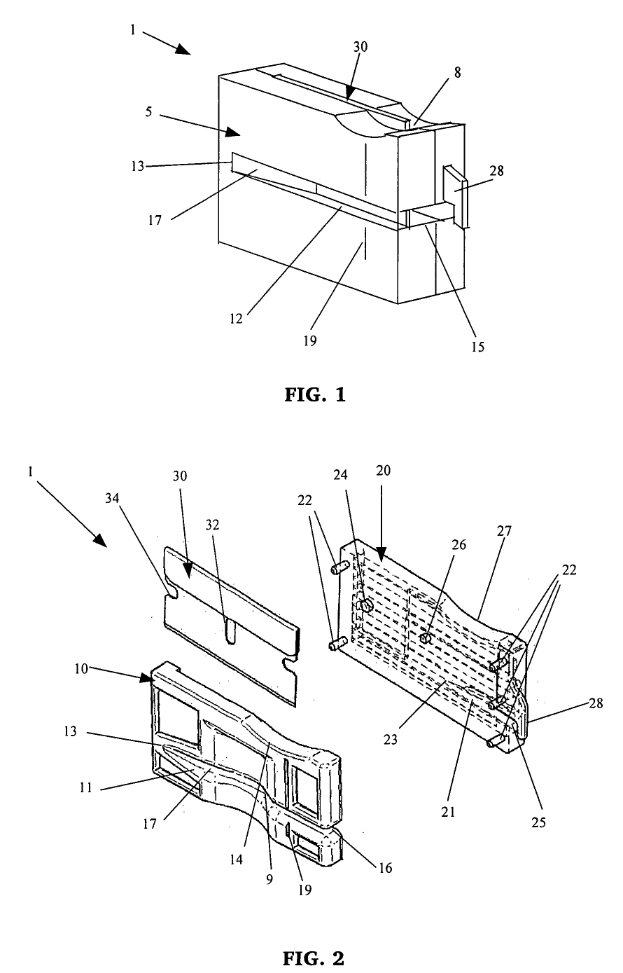

FIG. 1 shows a catheter trimmer, generally designated by reference number 1, according to an exemplary embodiment of the present invention. The catheter trimmer 1 may be used to trim any type of catheter, such as, for example, a peripherally inserted central (PIC) catheter, to an obliquely angled tip. The catheter trimmer 1 includes a blade housing 5 that houses a conventional razor blade 30. Alternatively, the razor blade 30 may be curvilinear so as to create a variety of catheter tip shapes. The blade housing 5 preferably has a rectangular profile to match that of the razor blade 30. However, the blade housing 5 may have any other suitable profile. The blade housing 5 may be made of plastic, or any other suitable material. The razor blade 30 is pivotable within the blade housing 5. The blade housing 5 includes a blade access indent 8 formed in the top surface of the blade housing 5, through which a portion of the top edge of the razor blade 30 is exposed. A catheter insertion guide 12 is formed in a side surface of the blade housing 5 and extends parallel to the razor blade 30 disposed within the blade housing 5 and perpendicular to the axis of pivot of the razor blade 30. The catheter insertion guide 12 includes a closed end 13, an open end 15 and an inner wall 17 that extends at an oblique angle from the closed end 13 of the catheter insertion guide 12 to a middle portion of the catheter insertion guide 12. When pivoted downwards, the razor blade 30 extends through the catheter insertion guide 12. A catheter tip holder 28 is formed on an end surface of the blade housing 5 adjacent to the open end 15 of the catheter insertion guide 12. As explained in further detail below, a catheter tip may be trimmed using the catheter trimmer 1 by grasping the top edge of the razor blade 30 exposed through the blade access indent 8, pivoting the razor blade 30 upwards to clear the catheter insertion guide 12, inserting a catheter tip into the catheter insertion guide 12 until the tip is held in place by the catheter tip holder 28, and then pushing the razor blade 30 downwards through the catheter insertion guide 12 to trim the catheter tip at an oblique angle.

The blade housing 5 may also include a trim line 19 formed on the outer surface of the blade housing 5. During use, a trim marking (e.g., cm marking) on the catheter may be lined up with the trim line 19 to ensure that the razor blade 30 trims the catheter to the appropriate length. Further, if the catheter tip has a varying profile, the trim line 19 is useful to provide a consistent trim cut by lining the trim line 19 up with a trim marking on the catheter tip.

Preferably, a catheter tip is trimmed to an angle within a range of 10° to 30°. This range reduces trauma caused by the catheter tip when inserted into a patient, while still providing the catheter tip with the necessary stiffness. Thus, the catheter insertion guide 12 is preferably inclined inwards from the outer surface of the blade housing 5 by an angle of 10° to 30° to provide the preferred catheter trim angle. The criticality of this angle range is supported by the results of the following example:

### EXAMPLE 1

The tip angle cut of a Tecothane® 5FR Power PICC catheter was evaluated to determine how the cuts affect catheter tip stiffness and insertion force. The results were compared to the Arrow Blue Flex Tip® catheters. Thirteen feather tip samples were prepared by cutting the samples at tip angles of 2, 3, 4, 5, 6, 8, 10, 15, 20, 30, 45, 75 and 90 degrees. The samples and the Arrow Blue Flex Tip catheters were tested for stiffness and compared. FIG. 4 shows the results represented in a boxplot 100 of tip stiffness (gm) vs. tip angle (degrees). A simulated flow loop was used having a flow loop viscosity of 3.3 cP at 37° C., a flow loop pressure of 24 mmHg and a flow loop flow rate of 2.0 L/min. Tip angles cut from 10-45 degrees were found to be easiest to insert as evaluated using the circulatory simulated flow loop.

The results of the above example show that tip angles cut from 10-45 degrees, and ideally 10-30 degrees, have similar tip stiffness values to the Arrow Blue Tip catheter, and thus causes less trauma during implantation.

FIG. 2 is an exploded perspective view of the catheter trimmer 1 according to an exemplary embodiment of the present invention. The catheter trimmer 1 includes a first housing portion 10 and a second housing portion 20 that are removeably fastened together by any suitable means, such as by a snapping action using locking pins 22 disposed on the inner face of the second housing portion 20 that removeably interlock with corresponding holes (not shown) formed in the inner face of the first housing portion 10. The first and second housing portions 10, 20 are locked together to hold the razor blade 30 therebetween. Although as shown here the housing 5 may have various portions that are separable from one another, it should be appreciated that the housing 5 may be a unitary structure that permanently houses a blade therein.

The razor blade 30 includes a central opening 32 and a side edge indent 34. In addition to the locking pins 22, the second housing portion 20 includes a blade pivot pin 24 disposed at a central portion of the inner surface of the second housing portion 20, and a blade pivot restrictor pin 26 disposed at an end portion of the inner surface of the second housing portion 20. The blade pivot pin 24 and blade pivot restrictor pin 26 mate with corresponding holes (not shown) formed in the inner surface of the first housing portion 10 to assist in locking together the first and second housing portions 10, 20. When the first and second housing portions 10, 20 are locked together, the blade pivot pin 24 provides a pivot point for the razor blade 30 by passing through the side edge indent 34 of the razor blade 30 and the blade pivot restrictor pin 26 limits the range that the razor blade 30 may pivot between the first and second housing 10, 20.

A first housing portion blade access indent 14 is formed in the top edge of the first housing portion 10, and a corresponding second housing portion blade access indent 27 is formed in the top edge of the second housing portion 20. The first housing portion blade access indent 14 mates with the second housing blade access indent 27 when the first and second housing portions 10, 20 are locked together, to form the blade access indent 8.

A longitudinally extending first housing groove 11 is formed in the outer surface of the first housing portion 10. The first housing groove 11 includes the closed end 13 formed at a first end portion of the outer surface of the first housing portion 10, and an open end 9 formed at a middle portion of the first housing portion 10, so that a slit 16 is formed in the first housing portion 10 extending from the middle portion of the first housing portion 10 to a second end of the first housing portion 10. The inner wall 17 of the first housing groove 11 extends obliquely from the closed end 13 to the open end 9.

A longitudinally extending second housing groove 21 is formed in the inner surface of the second housing portion 20. The second housing groove 21 includes a closed end 23 formed at a middle portion of the inner surface of the second housing portion 20 and an open end 25 formed in the longitudinal end surface of the second housing portion 20. When the first and second housing portions 10, 20 are locked together, the open end 9 of the first housing groove 11 is disposed adjacent the closed end 23 of the second housing groove 21, and the slit 16 overlaps the second housing groove 21, thus forming the catheter insertion guide 12.

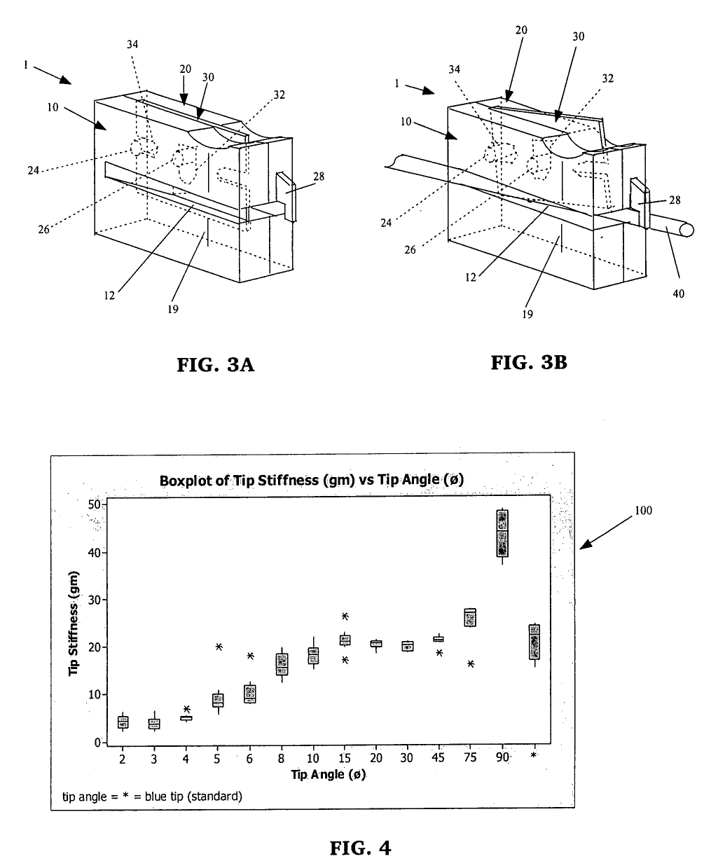

FIG. 3A shows the catheter trimmer 1 with the razor blade 30 in a pre-trimming position and FIG. 3B shows the catheter trimmer 1 with the razor blade 30 in a trimming position. In FIG. 3A, the razor blade 30 is pivoted upwards about the blade pivot pin 24 until the bottom edge of the central opening 32 of the razor blade 30 contacts the blade pivot restrictor pin 26, at which point the razor blade 30 is clear of the catheter insertion guide 12. A catheter tip 40 may then be inserted into the catheter insertion guide 12 and a trim marking on the catheter tip 40 may be lined up with the trim line 19 on the blade housing 5. Although the catheter tip 40 shown in FIGS. 3A and 3B is of a single-lumen variety, it should be appreciated that the catheter trimmer 1 may also be used to trim multi-lumen catheters. In FIG. 3B, the razor blade 30 is pivoted downwards about the blade pivot pin 24 until the top edge of the central opening 32 of the razor blade 30 contacts the blade pivot resistor pin 26, at which point the razor blade 30 has crossed into the catheter insertion guide 12 to trim the catheter tip 40 at an oblique angle.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A catheter trimmer comprising:
a blade housing including a catheter insertion guide that guides a tip of a catheter along a side of the blade housing at an oblique angle relative to the side of the blade housing; and
a blade disposed within the blade housing and pivotable about an axis perpendicular to the side of the blade housing, the blade having a pre-trimming position in which the blade is pivoted upwards to allow a catheter to be inserted into the catheter insertion guide, and a trimming position in which the blade is pivoted downwards through the catheter insertion guide to trim the catheter to the oblique angle.

2. The catheter trimmer of claim 1, wherein the catheter insertion guide comprises an inner wall that extends at the oblique angle to guide the tip of the catheter.

3. The catheter trimmer of claim 1, wherein the catheter insertion guide comprises a closed end formed at a first end portion of the housing and an open end formed at a second end portion of the housing.

4. The catheter trimmer of claim 3, further comprising a catheter tip holder disposed at an end surface of the blade housing adjacent the open end of the catheter insertion guide.

5. The catheter trimmer of claim 1, further comprising a blade access indent formed in the blade housing that exposes a portion of the blade to allow a user to grasp and pivot the blade.

6. The catheter trimmer of claim 1, wherein the blade housing further comprises an opening in which the blade is housed, and the catheter trimmer further comprises a pivot pin that extends across the housing through an end portion of the blade to provide a blade pivot point.

7. The catheter trimmer of claim 6, further comprising a pivot restrictor pin that extends across the housing though the blade to limit pivoting of the blade.

8. The catheter trimmer of claim 1, wherein the blade housing comprises a first blade housing portion and a second blade housing portion, and the first and second blade housing portions are separable from one another.

9. The catheter trimmer of claim 1, further comprising a trim line disposed on the blade housing for lining up the blade with a trim marking on the catheter.

10. The catheter trimmer of claim 1, wherein the oblique angle is in a range of 10° to 30°.

11. The catheter trimmer of claim 1, wherein the blade has a curvilinear profile.

12. A method of trimming a catheter, comprising:
pivoting a blade of a blade trimmer upwards to clear an obliquely-extending catheter insertion guide formed in a side of the blade trimmer;
guiding a catheter tip into the catheter insertion guide of the blade trimmer; and
pivoting the blade downwards into the catheter insertion guide to trim the catheter tip to the oblique angle.
